(19) United States
(12) Patent Application Publication
(10) Pub. No.: US 2019/0095714 A1
(43) Pub. Date: Mar. 28, 2019

(54) VEHICLE INTERIOR LIDAR DETECTION SYSTEMS

(71) Applicant: Panasonic Automotive Systems Company of America, Division of Panasonic Corporation of North America, Peachtree City, GA (US)

(72) Inventors: DANIEL D. WILCOX, FARMINGTON HILLS, MI (US); JENAT AWAD, FARMINGTON HILLS, MI (US)

(21) Appl. No.: 16/145,243

(22) Filed: Sep. 28, 2018

Related U.S. Application Data
(60) Provisional application No. 62/564,725, filed on Sep. 28, 2017.

(51) Int. Cl. G06K 9/00; G01S 17/89; H04N 5/232

(52) U.S. Cl. CPC G06K 9/00691; H04N 5/23229; G01S 17/89

(57) ABSTRACT

An item detection arrangement for a motor vehicle includes an image-capturing device capturing first and second images of a scene within a passenger compartment of the motor vehicle. The second image is captured after the first image has been captured. An electronic processor is communicatively coupled to the image-capturing device, and determines, based on the first image and the second image, that an item is present in the second image but is not present in the first image. The processor transmits an alert signal in response to the determination that an item is present in the second image but is not present in the first image. A user interface receives the alert signal. In response to receiving the alert signal, the user interface provides an indication to a human user of the motor vehicle that an item has been left in the motor vehicle.

### CROSS-REFERENCE TO RELATED APPLICATION

This application claims benefit of U.S. Provisional Application No. 62/564,725 filed on Sep. 28, 2017, which the disclosure of which is hereby incorporated by reference in its entirety for all purposes.

### FIELD OF THE INVENTION

The disclosure relates to a LIDAR system in a motor vehicle, which may be used to detect objects.

### BACKGROUND OF THE INVENTION

It is a common problem for objects to be accidentally left behind in personal vehicles, commercial vehicles and taxies. However, there is currently no electronic method of correcting or preventing this problem.

### SUMMARY

The present invention may use LIDAR (Light Detection and Ranging) technologies in the interior of a vehicle to determine changes in, or additions in, geometric shifts. LIDAR is a remote sensing method that uses light in the form of a pulsed laser at a specific frequency (which depends on the specific application) to measure distance to objects. These laser light pulses generate precise three-dimensional information about the interior of a vehicle and its characteristics. The invention may include creating a three-dimensional topographic map with accuracy in the range of a few millimeters.

A standard LIDAR image may be obtained (several methods of obtaining this may be performed) before an occupant enters the vehicle, and another image can be captured as the occupant departs the vehicle. A differentiating comparison between the two images can be quickly made, and the occupant may be alerted by horn, lights, etc. that an item may have been left behind in the vehicle.

Personal items such as papers, wallets, phones, bags, jackets, umbrellas, etc. can be detected by the inventive imaging system and the passenger may be alerted of the items that possibly have been accidentally left behind.

An eye-safe LIDAR system may be employed so that the vehicle occupants) are not exposed to harmful lasers that can be absorbed by the eye, such as InGaAs (Indium Gallium Arsenide).

One of the LIDAR systems can be located in the front seat area of the passenger compartment, such as by the rearview mirror. Another one of the LIDAR systems can be located in the rear seat area of the passenger compartment to provide maximum laser exposure to the seats, the floor, and areas surrounding the rear seats.

A beep, horn, lights, any two of these used in combination, or all three used in combination can be employed to alert the passenger/driver that an item may have been deft behind in the vehicle.

In one embodiment, the invention comprises an item detection arrangement for a motor vehicle, including an image-capturing device capturing first and second images of a scene within a passenger compartment of the motor vehicle. The second image is captured after the first image has been captured. An electronic processor is communicatively coupled to the image-capturing device, and determines, based on the first image and the second image, that an item is present in the second image but is not present in the first image. The processor transmits an alert signal in response to the determination that an item is present in the second image but is not present in the first image. A user interface is communicatively coupled to the electronic processor and receives the alert signal. In response to receiving the alert signal, the user interface provides an indication to a human user of the motor vehicle that an item has been left in the motor vehicle.

In another embodiment, the invention comprises an item detection method for a motor vehicle, including capturing first images of a scene within a passenger compartment of the motor vehicle, and capturing second images of the scene within the passenger compartment of the motor vehicle. The second image is captured after the first image has been captured. It is determined, based on the first image and the second image, that an item is present in the second image but is not present in the first image. An alert signal is transmitted in response to the determination that an item is present in the second image but is not present in the first image. In response to receiving the alert signal, an indication is provided to a human user of the motor vehicle that an item has been left in the motor vehicle.

In yet another embodiment, the invention comprises an item detection arrangement for a motor vehicle. The arrangement includes a sensor detecting a door of the vehicle opening and/or closing. An image-capturing device captures a first image of a scene within a passenger compartment of the motor vehicle. After the first image has been captured, the image-capturing device captures a second image of the scene within the passenger compartment of the motor vehicle in response to the sensor detecting the door of the vehicle opening and/or closing. An electronic processor is communicatively coupled to the sensor and to the image-capturing device. The electronic processor determines, based on the first image and the second image, that an item is present in the second image but is not present in the first image. The electronic processor transmits an alert signal in response to the determination that an item is present in the second image but is not present in the first image. A user interface is communicatively coupled to the electronic processor and receives the alert signal. In response to receiving the alert signal, the user interface provides an indication to a human user of the motor vehicle that an item has been left in the motor vehicle.

### BRIEF DESCRIPTION OF THE DRAWINGS

A better understanding of the present invention will be had upon reference to the following description in conjunction with the accompanying drawings.

FIG. 1 is a block diagram of one example embodiment of a vehicle interior LIDAR-based item detection arrangement of the present invention.

FIG. 2 is an example image captured by the LIDAR system of the arrangement of FIG. 1.

FIG. 3 is another example image captured by the LIDAR system of the arrangement of FIG. 1.

FIG. 4 is an image calculated as a difference between the images of FIGS. 2 and 3.

FIG. 5 is a flow chart of one embodiment of an item detection method of the present invention for a motor vehicle.

### DETAILED DESCRIPTION OF THE PREFERRED EMBODIMENTS

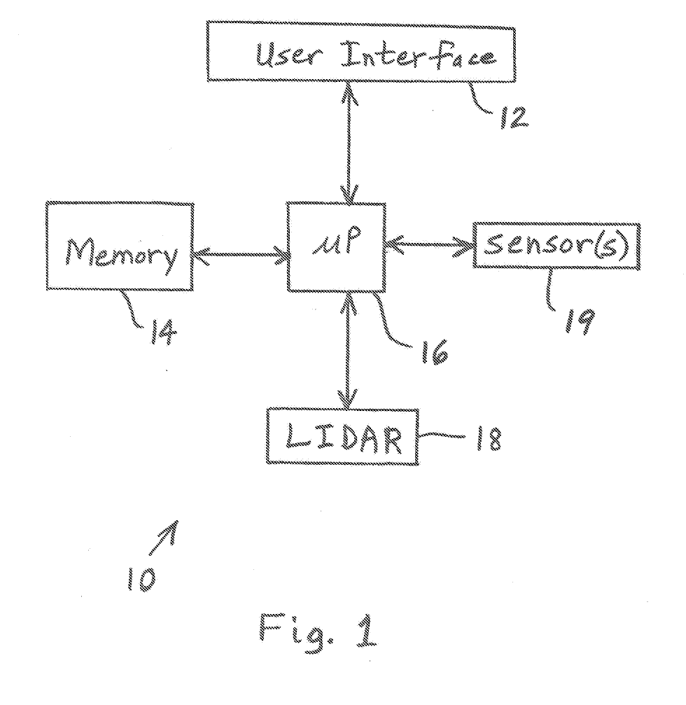

FIG. 1 illustrates one example embodiment of a vehicle interior LIDAR-based item detection arrangement 10 of the present invention installed in a motor vehicle. Arrangement 10 includes a user interface 12, a memory device 14, an electronic processor 16, a LIDAR system 18, and one or more sensors 19. User interface 12 may include an audio system, a horn, and/or a light, for example. In general, user interface 12 may include any medium that is capable of informing a user that an item has been left behind in the motor vehicle.

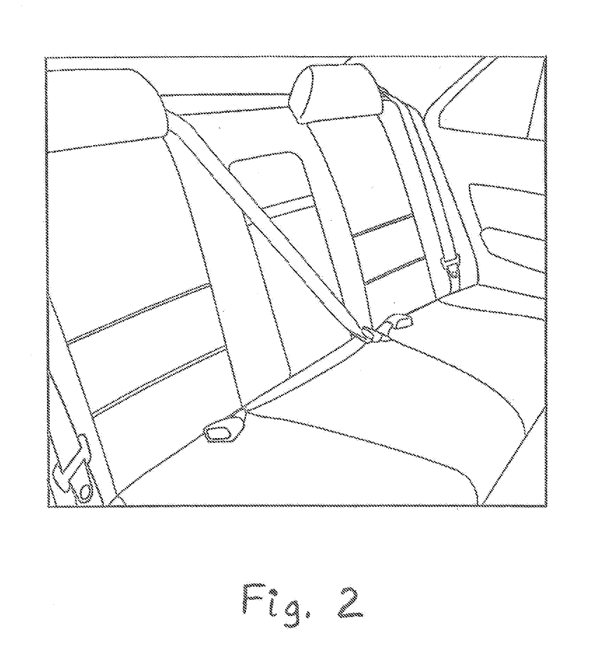

During use, LIDAR system 18 may capture an initial image of the interior of the motor vehicle so that a comparison may be made with a later-captured image. An example of such an initial image or standard image is illustrated by FIG. 2, which indicates how a LIDAR image may define the current backseat geometric configuration. LIDAR system 18 may transmit the standard image to processor 16, and processor 16 may store the standard image in memory 14.

There are several methods by which the standard LIDAR image may be obtained within the scope of the invention. In a first method, a standard image can be composed by the original equipment manufacturers (OEMs) of the vehicle. This first method has the advantages of precise calibration for each vehicle and having an image defaulted into a database. The risk is that, over time, seatbelts may get stuck and/or loose. Over time, seats change their geometric shape due to general wear or permanent disfigurement, such as holes being worn in the seats. Additionally, after the OEM creates the standard image, passengers may intentionally leave bags and other items in the vehicle. Based on the original standard image created by the OEM, this may cause an alert every single time a passenger exits the vehicle and intentionally leaves an item in the vehicle.

In a second method, a standard image can be composed using a timed method. In such instances, the vehicle, based on a schedule or specified interval, may inform the driver only when items differentiate from the last time an original image was captured. For example, an initial LIDAR image may be captured just as a car door is opened, as detected by sensor 19. The benefit is that what is currently in the vehicle becomes part of the original image (such as a hand bag), and the alarm goes off only if additional items are added, or there is a significant shift in the position of existing items.

In a third method, false positives may be reduced by reducing the total LIDAR coverage area to specific localized focus areas, such as vehicle seats. In this instance, items left on the floor may not be scanned, and the passenger may not be alerted. However, items left on car seats may cause a significant differentiating comparison to occur and a signal to be sent to passengers.

In a fourth method, instead of covering the area and using one-for-one comparisons, item tracking may be used. In this instance, items with specific geometric sizes (such as wallets, keys, purses, bags) could be tracked and reported.

In a fifth method, a combination of the above methods is employed. For example, item tracking may be combined with localized focus areas.

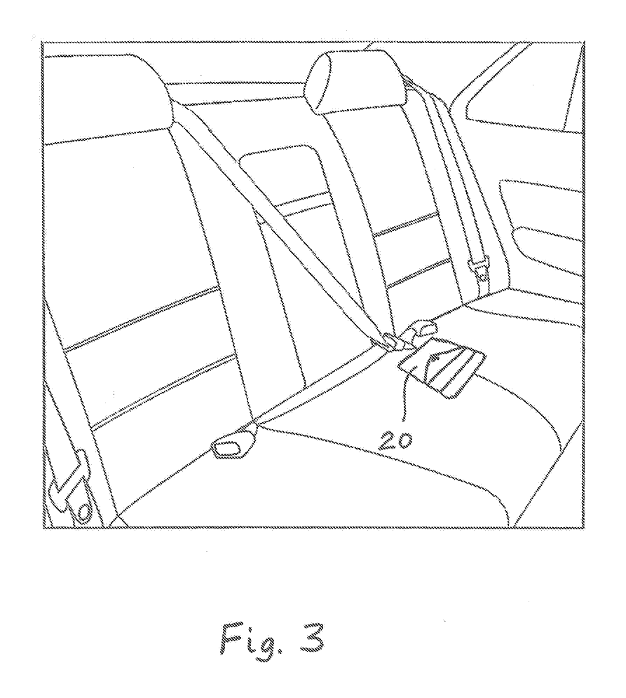

FIG. 3, which is an image that is captured after the image of FIG. 2 is captured, indicates that a wallet 20 has been left behind on a rear seat of the motor vehicle. LIDAR system 18 may quickly capture the image of FIG. 3 in response to a rear passenger door of the motor vehicle being opened and/or closed, as detected by sensor 19 for example.

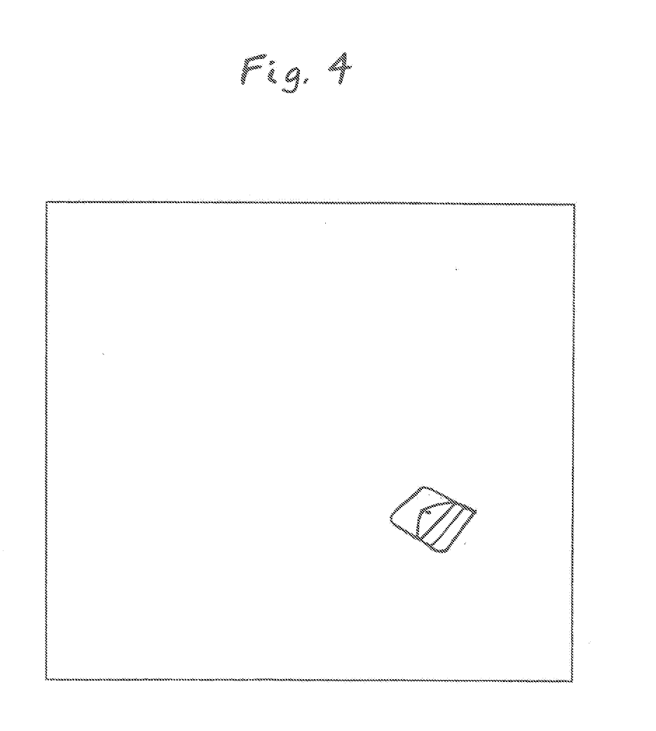

FIG. 4 illustrates a differential image resulting from a comparison between FIGS. 2 and 3. In one embodiment, the similarities of the two pictures of FIGS. 2 and 3 are subtracted (removed) from the picture of FIG. 3. If no object has been left behind in the vehicle, then the differential image may be virtually blank. However, as can be seen in a comparison between FIGS. 2 and 3, a wallet was left behind on the rear seat. Accordingly, as illustrated in FIG. 4, LIDAR system 18 and processor 16 have detected a difference between the two pictures in the form of wallet 20. Because the analysis reveals that an item has been left in the vehicle, an alert may be sent to the passenger and the driver informing them that an item has possibly been left behind in the vehicle.

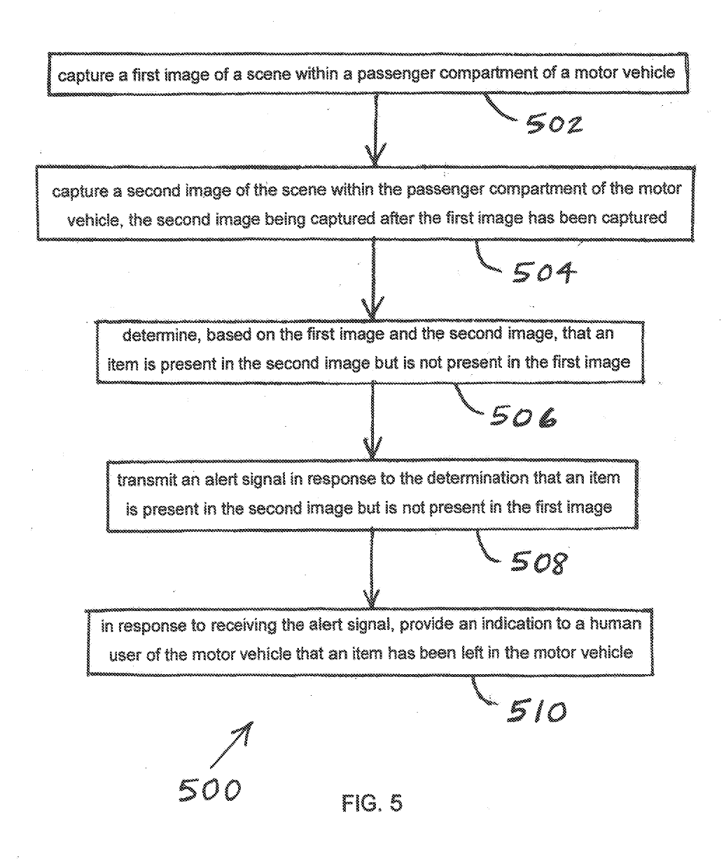

FIG. 5 illustrates one embodiment of an item detection method 500 of the present invention for a motor vehicle. For example, in a first step 502, a first image of a scene within a passenger compartment of the motor vehicle is captured. For example, LIDAR system 18 may capture an initial image of the interior of a motor vehicle as illustrated in FIG. 2.

Next, in step 504, a second image of the scene within the passenger compartment of the motor vehicle is captured. The second image is captured after the first image has been captured. For example, LIDAR system 18 may quickly capture the image of FIG. 3 in response to a rear passenger door of the motor vehicle being opened and/or closed, as detected by sensor 19. FIG. 3 is captured after the image of FIG. 2 is captured.

In a next step 506, it is determined, based on the first image and the second image, that an item is present in the second image but is not present in the first image. For example, FIG. 4 illustrates a differential image resulting from a comparison between FIGS. 2 and 3. The similarities of the two pictures of FIGS. 2 and 3 are subtracted (removed) from the picture of FIG. 3 in order to arrive at the picture of FIG. 4. As can be seen in FIG. 4, a wallet was left behind on the rear seat. Accordingly, LIDAR system 18 and processor 16 have detected that wallet 20 is in FIG. 3 but not in FIG. 2.

In step 508, an alert signal is transmitted in response to the determination that an item is present in the second image but is not present in the first image. For example, an electronic alert signal may be transmitted to activate the vehicle's audible horn or lights, or a wireless signal may be sent to the occupant's mobile personal device.

In a final step 510, in response to receiving the alert signal, an indication is provided to a human user of the motor vehicle that an item has been left in the motor vehicle. For example, in response to receiving the signal, the vehicle may activate the vehicle's audible horn or lights to catch the occupant's attention. Alternatively, the occupant's mobile personal device may inform the occupant of an incoming text message or telephone call, wherein the text message or phone call informs the occupant that an item may have been left behind in the vehicle.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for dearness of understanding and no unnecessary limitations are to be understood therefrom for modifications can be made by those skilled in the art upon reading this disclosure and may be made without departing from the spirit of the invention.

What is claimed is:

1. An item detection arrangement for a motor vehicle, the arrangement comprising:
an image-capturing device configured to:
capture a first image of a scene within a passenger compartment of the motor vehicle; and
capture a second image of the scene within the passenger compartment of the motor vehicle, the second image being captured after the first image has been captured;
an electronic processor communicatively coupled to the image-capturing device, the electronic processor being configured to:
determine, based on the first image and the second image, that an item is present in the second image but is not present in the first image; and
transmit an alert signal in response to the determination that an item is present in the second image but is not present in the first image; and
a user interface communicatively coupled to the electronic processor and configured to:
receive the alert signal; and
in response to receiving the alert signal, provide an indication to a human user of the motor vehicle that an item has been left in the motor vehicle.

2. The arrangement of claim 1 wherein the image-capturing device comprises a LIDAR system.

3. The arrangement of claim 1 further comprising a sensor communicatively coupled to the electronic processor and configured to detect a door of the vehicle opening and/or closing, the image-capturing device being configured to capture the second image in response to the sensor detecting the door of the vehicle opening and/or closing.

4. The arrangement of claim 1 wherein the electronic processor is configured to determine, based on a comparison between the first image and the second image, that an item is present in the second image but is not present in the first image.

5. The arrangement of claim 1 wherein the electronic processor is configured to determine, based on subtracting elements of the first image from elements of the second image, that an item is present in the second image but is not present in the first image.

6. The arrangement of claim 1 wherein the first image and the second image are of a seat of the motor vehicle.

7. The arrangement of claim 1 wherein the user interface is configured to provide an indication, in the form of a beep, a horn or a light, to a human user of the motor vehicle that an item has been left in the motor vehicle.

8. An item detection method for a motor vehicle, the method comprising:
capturing a first image of a scene within a passenger compartment of the motor vehicle;
capturing a second image of the scene within the passenger compartment of the motor vehicle, the second image being captured after the first image has been captured;
determining, based on the first image and the second image, that an item is present in the second image but is not present in the first image;
transmitting an alert signal in response to the determination that an item is present in the second image but is not present in the first image; and
in response to receiving the alert signal, providing an indication to a human user of the motor vehicle that an item has been left in the motor vehicle.

9. The method of claim 8 wherein the first image and the second image are captured by a LIDAR system.

10. The method of claim 8 further comprising detecting a door of the vehicle opening and/or closing, the second image being captured in response to the detecting of the door of the vehicle opening and/or closing.

11. The method of claim 8 wherein the determining step includes determining, based on a comparison between the first image and the second image, that an item is present in the second image but is not present in the first image.

12. The method of claim 8 wherein the determining step includes determining, based on subtracting elements of the first image from elements of the second image, that an item is present in the second image but is not present in the first image.

13. The method of claim 8 wherein the first image and the second image are of a seat of the motor vehicle.

14. The method of claim 8 wherein the indication is in the form of a beep, a horn or a light.

15. An item detection arrangement for a motor vehicle, the arrangement comprising:
a sensor configured to detect a door of the vehicle opening and/or closing;
an image-capturing device configured to:
capture a first image of a scene within a passenger compartment of the motor vehicle; and
after the first image has been captured, capture a second image of the scene within the passenger compartment of the motor vehicle in response to the sensor detecting the door of the vehicle opening and/or closing;
an electronic processor communicatively coupled to the sensor and the image-capturing device, the electronic processor being configured to:
determine, based on the first image and the second image, that an item is present in the second image but is not present in the first image; and <transmit an alert signal in response to the determination that an item is present in the second image but is not present in the first image; and
a user interface communicatively coupled to the electronic processor and configured to:
receive the alert signal; and
in response to receiving the alert signal, provide an indication to a human user of the motor vehicle that an item has been left in the motor vehicle.

16. The arrangement of claim 15 wherein the image-capturing device comprises a LIDAR system.

17. The arrangement of claim 15 wherein the electronic processor is configured to determine, based on a comparison between the first image and the second image, that an item is present in the second image but is not present in the first image.

18. The arrangement of claim 15 wherein the electronic processor is configured to determine, based on subtracting elements of the first image from elements of the second image, that an item is present in the second image but is not present in the first image.

19. The arrangement of claim 15 wherein the first image and the second image are of a seat of the motor vehicle.

20. The arrangement of claim 15 wherein the user interface is configured to provide an indication, in the form of a beep, a horn or a light, to a human user of the motor vehicle that an item has been left in the motor vehicle.
